(19) United States
(12) Patent Application Publication
(10) Pub. No.: US 2014/0061124 A1
(43) Pub. Date: Mar. 6, 2014

(54) EFFLUENT TREATMENT PROCESS AND PLANT

(71) Applicant: Philippe Michel, Sainte Foy Les Lyon (FR)

(72) Inventor: Philippe Michel, Sainte Foy Les Lyon (FR)

(21) Appl. No.: 14/115,098

(22) PCT Filed: May 3, 2012
(86) PCT No.: PCT/EP2012/058119

§ 371 Date: Oct. 31, 2013

(30) Foreign Application Priority Data
May 3, 2011 (FR) FR 1153754

(51) Int. Cl. C02F 3/30

(52) U.S. Cl. CPC C02F 3/302
USPC 210/602; 210/170.03

(57) ABSTRACT

An effluent treatment process and plant. The treatment includes at least one passage of the effluents through a device for biological pretreatment of the effluents, such as a bacterial bed, a lagoon or lagooning or a biological disc, at least one nitrification-denitrification of the pretreated effluents resulting from the biological pretreatment device, using a vertical-flow filter planted with rhizome plants, for example reeds, of which a lower zone is flooded and an upper zone is unflooded, and a device for injecting coagulants capable of precipitating the phosphates of effluents, for example ferric chloride salts.

### FIELD OF THE INVENTION

The technical field to which the invention relates is that of methods and installations for the bio-physico-chemical treatment of effluents, comprising the use of a filter planted with vascular rhizome plants, for example a filter planted with reeds, for carrying out the treatment, and more particularly for the nitrification-denitrification and dephosphatisation of effluents.

In general terms, the treatment capacity envisaged corresponds to that which is necessary for small and medium communities, that is to say communities of less than 10,000 equivalent inhabitants (EI) and usually from 50 to 2000 EI.

### TECHNICAL CONTEXT OF THE INVENTION

The purification of waste water can be defined as all the techniques intended to collect the water, discharge it and treat it to an acceptable level by means of the receiving environment. Thus the purification of waste water is intended not to produce drinking water but to reduce the pollution resulting from the waste water. There are several polluting phenomena, including in particular:
matter in suspension, mainly responsible for the turbid appearance or cloudiness of the waste water,
oxidisable materials, in particular organic oxidisable materials, which consume the oxygen dissolved in the water and may cause asphyxia of living organisms,
the nitrogenous compounds responsible, with phosphorated materials, for the eutrophication of stretches of water.

European Directive 91.271/EEC of the Council of May 21, 1991, relating to the treatment of urban waste water, poses objectives for the collection and treatment of the waste water. The treatment or purification of the waste water requires a series of successive steps, each of which relates to a particular type of pollutant. There are thus primary treatments intended to eliminate the coarsest pollutants (branches, pebbles, sand, etc.) and to retain the fraction of the pollution that can be settled, the matter in suspension.

The secondary treatment, usually a biological treatment, is mainly intended to attack the pollution in dissolved or colloidal form. The secondary treatment mainly degrades the organic matter, on the one hand into an oxidized fraction resulting in the production of CO₂ via bacterial respiration, and on the other hand a fraction comprising new bacterial cells, normally referred to as purification sludge. The secondary treatment therefore corresponds to a transformation of the organic matter rather than a complete elimination of it.

Tertiary treatments aim to eliminate in particular the nitrogen before discharging the treated effluents into the environment.

Tertiary treatments also aim to eliminate phosphorus and in particular organic and inorganic phosphates.

There exist several types of secondary treatment for the biological elimination of polluting matter. Such biological treatments attempt to reproduce self-purification phenomena existing in nature. In particular extensive biological processes and intensive biological processes can be distinguished. Among extensive biological processes, lagooning uses the purifying capacity of shallow stretches of water. The waste water is sent into a series of pools. The oxygen necessary for treatment is contributed by the exchanges with the atmosphere. It is generally considered that this purification method makes it possible to eliminate 80% to 90% of the BOD₅ and 20% to 30% of the nitrogen and that it contributes to a significant reduction in pathogenic germs. However, it has the drawback of using large surface areas.

Intensive biological processes include in particular activated-sludge installations, fixed-culture installations and biofiltration. Activated-sludge installations are aerobic purification systems. The bacterial culture is maintained in an aerated pool and stirred. The residues formed are referred to as purification sludges. After a residence time in an aeration pool, the effluent is sent into a secondary clarifier or settler. Then the sludge is either sent into a specific treatment unit, with a view to agricultural spreading or elimination thereof, or reinjected partly into the aeration pool. Generally, treatments by activated sludge eliminate on average 85% to 95% of the BOD₅, depending on the installation. This is a simple biological treatment but one that requires large surface areas and does not integrate well in the landscape.

In a fixed-culture installation, for example a bacterial bed, the water to be treated is trickled over a solid support where a culture of purifying microorganisms, the biological film or a biofilm, develops. During the functioning of the installation, when the biofilm becomes too large, it detaches naturally. It must then be separated from the effluent by settling, for example in a secondary settler. It is estimated that fixed-culture installations are generally suited to installations with a size of less than 2000 EI. They on average eliminate 80% of the BOD₅.

The elimination of nitrogen is generally achieved by nitrification-denitrification. The organic nitrogen present in the waste water is transformed into ammoniacal nitrogen (NH₄⁺). In an aerobic environment, under the influence of nitrifying bacteria, the ammoniacal nitrogen is oxidized into nitrates NO₃, which corresponds to the nitrification step. Then the denitrification, under the action of denitrifying bacteria, completes the process. This is the reduction in an anoxic environment of the nitrates into gaseous nitrogen N₂, which then escapes into the atmosphere. The denitrifying bacteria use the nitrates as a source of oxygen. They consume the organic matter in the environment, and in the case of a deficit of organic matter the source of carbon is contributed in the form of methanol.

The two nitrification and denitrification steps are formed in distinct installations, because of the differences in environmental conditions necessary for the correct functioning thereof.

There exist various techniques for elimination of phosphorus that are divided into two main categories:
elimination techniques involving a biological process,
elimination techniques involving a physico-chemical process leading to the precipitation of the phosphorus salt.

The biological elimination consists of accumulating the phosphorus in the biomass produced by biological treatment of the effluents. The over-accumulation of phosphorus in the biomass may be obtained for example by placing the biomass alternatively in anaerobic and aerobic phase. However, this process, in the best of cases, results in providing partial elimination of the phosphorus in the water to be treated, requiring biochemical elimination in addition.

The physico-chemical elimination of the phosphorus (or chemical dephosphatisation) consists of adding a coagulant or precipitating agent such as calcium, or metal salts, in particular trivalent ions such as iron and aluminum. However, the biological treatment mode, the conditions under which this biological is effected and the characteristics of the effluent to be treated have a great influence on the efficacy of the chemical dephosphatisation processes. In particular, under certain conditions, the precipitated phosphorus may be resolubilised in the effluent treated, leading to a reduction in efficiency (Caravelli et al, Journal of Hazardous Materials 177 (2010) 199-208).

It is thus difficult to predict the efficacy of a phosphorus elimination treatment according to the type of installation used for the treatment of effluent.

The patent application FR 2900921 describes a method for the treatment of effluent by nitrification-denitrification using at least one filter planted with reeds with vertical flow. This application concerns essentially waste water nitrification-denitrification methods with a view to the elimination of the total nitrogen.

It is to the merit of the inventors that they have identified that the features of the methods and installations described in the application FR 2900921 also enable dephosphatisation of effluents by physico-chemical method with a particularly high efficiency.

Without being bound by any theory, it may be that these high efficiencies result from the favorable environmental conditions of the filters planted with reeds described in the application FR 2900921, preventing the resolubilisation of the phosphate salts. Furthermore, advantageously, the effluents pretreated, for example on a bacterial bed, being brought by batch onto the filter planted with reeds, the metal salts or other coagulating agents enabling precipitation of the phosphates, may be easily injected, after the treatment on a bacterial bed and before the batch in a controlled manner.

Thus the present invention sets out to provide small and medium communities with methods and installations for treating effluents comprising both the elimination of nitrogenous pollutants by nitrification-denitrification, and elimination of the phosphatised pollutants, in particular taking account of the constraints listed non-exhaustively as follows:
an installation not requiring very great maintenance, in particular with regard to the financial, technical and human resources of the community,
ease of use of the installation and implementation of the method,
limitation of costs, in particular in terms of energy requirements or expropriation of property,
improvement of the purification efficiency,
good integration of the installation in the landscape,
elimination of the various pollutants referred to in the Directive mentioned above, including nitrogenous and phosphatised pollutants,
reduction of the volume of final purification product that cannot be reprocessed,
optimization of the volume of final purification products that can be reprocessed,
elimination of bad odors, due in particular to the anaerobic functioning of certain water purification installations.

Thus at least one essential objective of the invention is to propose a method for treating effluent and an installation for this purpose, which satisfies at least one of the constraints mentioned above.

In particular, one objective of the invention is to propose a method for the treatment of effluent, able to be implemented in an installation the functioning of which can be supported by a small community, in particular from the point of view of the investment costs and operating costs.

Another objective of the invention is to propose an effluent treatment method comprising the elimination of the main pollutants, including the matter in suspension, the organic matter, the nitrogenous pollutants and the phosphatised pollutants.

Another objective of the invention is to propose a method and installation for treating effluent that limits the release of bad odors.

Other objectives and advantages of the invention will be indicated in the following description.

### BRIEF DESCRIPTION OF THE INVENTION

Thus the invention concerns first of all an effluent treatment method comprising the following steps:
A biological pretreatment of the effluent is performed, for example by means of at least one bacterial bed, in particular for fixing the soluble organic pollution by means of the action of the purifying bacteria of the bacterial bed. Pretreated effluent is obtained at the discharge.
A biological nitrification-denitrification treatment of the pretreated effluent obtained is carried out, by means of a filter planted with vascular rhizome plants, for example a filter planted with reeds, with vertical flow. The pretreated effluent recovered on the surface constitutes a source of carbon for the denitrification.
A physico-chemical dephosphatisation treatment of the effluent is carried out, preferably after the biological pretreatment step and before the biological nitrification-denitrification treatment step.

The physico-chemical dephosphatisation treatment of the effluent consists typically of injecting coagulating agents able to precipitate the phosphates in the effluent or purification sludge before the biological nitrification-denitrification treatment. Such coagulating agents may for example be chosen from iron salts such as ferric chloride or ferrous iron sulfate.

Preferably the flow of effluent in the filter planted with reeds takes place under the simple action of gravity. The nitrification and denitrification take place simultaneously in the same planted filter specifically configured for this purpose.

In a particular embodiment of the method according to the invention, this also comprises the following steps:
a. the pretreated effluent from the biological pretreatment is recovered, for example on a bacterial bed or a biological disc, in a pumping station before the nitrification-denitrification step,
b. said coagulating agent are injected in the pumping station containing the effluent recovered at a.,
c. where applicable, the effluent is agitated in the pumping station after injection of the coagulating agents, so as to obtain a good dispersion of the coagulating agents in the effluent,
d. the effluent is discharged from the pumping station just after step b. and/or c., onto the filter planted with vascular rhizome plants, for example a filter planted with reeds,
e. the sludge containing the precipitates of phosphates and particulate phosphorus is recovered on the surface of the planted filter.

In a particular variant of the method according to the invention, in permanent functioning regime, at least one nitrification-denitrification filter comprises a non-flooded upper zone and a flooded lower zone where respectively an essentially aerobic nitrification biological treatment and an essentially anaerobic denitrification biological treatment take place. In particular, in permanent functioning regime, the height of the flooded zone of at least one nitrification-denitrification filter, preferably the first nitrification-denitrification filter, is greater than or equal to the height of its non-flooded zone.

According to a preferred variant of the method according to the invention, it is not necessary to add a supplementary carbon source (for example methanol) in order to carry out the treatment. In other words, the carbonaceous load of the effluent or purification sludge is sufficient.

Secondly, the invention concerns an effluent treatment installation, designed in particular for implementing the method according to the invention. The installation comprises:
at least one device for the biological pretreatment, for example a bacterial bed or a biological disc, equipped with a supply of effluent to be treated and a discharge of the effluent obtained at the exit from said device,
at least one nitrification-denitrification stage comprising a filter planted with vascular rhizome plants, for example a filter planted with reeds, with vertical flow, the top surface of which is equipped with a supply of pretreatment effluent coming at least partly from said device, and the bottom of which is equipped with a drainage device for collecting the effluent that has flowed through the planted filter,
a device for discharging the effluent collected from the drainage device comprising at least one discharge orifice disposed at a height lying between the bottom of the filter and the top surface of the filter, thus forming a flooded lower zone and a non-flooded upper zone in the planted filter,
means for injecting coagulating agents able to precipitate the phosphates in the effluent or purification sludge, for example ferric chloride salts.

In a preferred variant, the means for injecting the coagulating agents comprise:
a storage tank comprising the coagulating agents able to precipitate the phosphates in the effluent or purification sludge, for example ferric chloride salts,
a metering pump for injecting an appropriate concentration of salts into the pretreated effluent,
where applicable, means for the automatic control of the metering pump, for the controlled injection of an appropriate concentration of coagulating salts into the pretreated effluent, preferably just before discharge thereof by batch onto the vertical-flow planted filter,
where applicable, means for obtaining a good dispersion of the coagulating agents in the pretreated effluent in the injection zone, for example in the pumping station.

The installation is characterized in that the effluent collected by the drainage device is discharged from the nitrification-denitrification stage by means of an effluent discharge device comprising at least one discharge orifice disposed at a height lying between the bottom of the filter and the top surface of the filter. Thus a flooded lower zone and a non-flooded upper zone are formed in the filter planted with reeds. The height of the flooded zone corresponds to the height of the discharge orifice (or of the lowest discharge orifice if several orifices are present, but advantageously all the discharge orifices associated with a given filter are at the same height).

According to a variant of the invention, the effluent discharge device comprises a reservoir provided with at least one orifice for supplying effluent collected by the drainage device and also provided with at least one effluent discharge orifice, the discharge orifice being in the form of an overflow the height of which is advantageously controllable.

According to a variant of the invention, the installation comprises at least two successive nitrification-denitrification stages, the height of the flooded zone of the first stage being different from the height of the flooded zone of at least one following stage.

According to a variant of the invention, the planted filter of each nitrification-denitrification stage is divided into a plurality of cells, preferably at least three cells, and each cell is supplied with effluent by circular permutation over time.

According to a variant of the invention, the installation also comprises a device for the recirculation of the effluent collected by a drainage device to at least one preceding nitrification-denitrification stage and/or to the bacterial bed. Advantageously, the effluent recirculation device is slaved to at least one detector for the volume of effluent to be treated and/or to a detector for the locality of the effluent obtained at the discharge from the installation.

The invention will be better understood from a reading of the following detailed description, accompanied by the attached drawings, which form an integral part of the description.

### BRIEF DESCRIPTION OF THE FIGURES

FIG. 1 is a schematic representation of a variant of an effluent treatment installation according to the invention.

FIG. 2 shows a variant of the supply devices of the nitrification-denitrification stages.

FIG. 3 shows a detail of the installation and illustrates a variant for controlling the height of the flooded zone and the non-flooded zone, in a filter planted with reeds.

### DETAILED DESCRIPTION OF THE INVENTION

For a good understanding of the invention, various terms will be defined. The concept of equivalent inhabitant (El) is used in purification to assess the capacity purification stations. European Directive 91/271/EEC of the Council of 20 May 1991 defines an equivalent inhabitant as the biodegradable organic load having a five-day biochemical oxygen demand (BOD₅) of 60 g of oxygen per day. It is generally considered that the pollution caused by an equivalent inhabitant is as follows:
matter in suspension: 90 grams/EI/day,
oxidisable matter: 57 grams/EI/day,
total nitrogen: 15 grams/EI/day,
total phosphorus: 4 grams/EI/day.

The five-day biological oxygen demand (BOD₅) is the quantity of oxygen that it is necessary to supply to a sample of water in order to mineralize the biodegradable organic matter contained in the water, by biochemical method, that is to say by oxidation by means of aerobic bacteria. This parameter is based on the quantification of the oxygen consumed after incubation of the sample for five days, in accordance with the standard FT 90-103. The BOD₅ is expressed in mg/l.

The chemical oxygen demand (COD) is determined by measuring the quantity of potassium dichromate consumed by the matter dissolved in suspension. The COD represents, as a quantity of oxygen, the oxidation potential of a chemical oxidant decomposed by the reducing substances contained in the sample examined. The measurement of the COD takes account indifferently of the mineral and organic substances present in the sample. The COD is measured in accordance with NFT 90-101 and is expressed in mg/l.

The matter in suspension (MIS) has two polluting effects. First of all, the MIS leads to the formation of sediments and to an increase in the cloudiness of the water, which limits the penetration of light. Furthermore, the MIS requires oxygen for metabolization thereof, which causes oxygen depletion in the environment. The MIS is measured in accordance with NFT 90-105 and is expressed in mg/I.

Nitrogenous pollution is measured in various ways, according to the chemical species in question:
ammoniacal nitrogen is measured in accordance with NFT 90-015;
Kjeldahl nitrogen (NTK) is measured in accordance with NFT 90-110. This measurement is based on the transformation of the nitrogenous compounds analyzable by mineralization of the sample. Kjeldahl nitrogen therefore represents the reduced forms of nitrogen, that is to say organic nitrogen and ammoniacal nitrogen;
the nitrates and nitrites are analyzed respectively in accordance with NFT 90-012 and NFT 90-013.

These various measurements of nitrogen are expressed in mg/l.

In accordance with NF-EN 1189, phosphatised pollution is measured as follows:
orthophosphates are measured in accordance with NF-EN 1189. This method concerns spectrometric analysis by means of ammonium molybdate;
hydrolysable polyphosphates are measured after transformation by sulfuric-acid hydrolysis into orthophosphates;
total phosphorus is measured after transformation into orthophosphate. NF-EN 1189 proposes two methods for extraction-mineralization of phosphorus: one using persulphate, the other, more energetic, using sulfuric and nitric acid.

These various measurements of phosphorus are expressed in mg/I.

A filter planted with vascular rhizome plants generally comprises a ditch, the walls of which are impermeable to water. The ditch comprises excessive layers of filling and filtration materials, the granulometry of which is controlled. The top surface is planted with vascular rhizome plants, for example reeds, in particular the species Phragmites australis. Any type of vascular rhizome plant, and in particular those known from the prior art for filtering effluent, may be used. Species of reed will be mentioned in particular. Other wetland plants can be envisaged, such as other species of the genus Phragmites or species of the genera Scirpus or Typha. The species in the Juncus genus will also be mentioned. The choice of the species, or of the mixture of species, used depends in particular on the development conditions of the plants chosen, the climate and the abundance of effluent.

In a filter planted with vascular rhizome plants with vertical flow, the granulometry of the filling materials increases from top to bottom: the upper layers comprise for example sand, while the intermediate and lower layers comprise for example, respectively, gravel and pebbles in order to provide drainage. Thus the effluent to be treated arrives at the upper surface of the filter and is discharged at the lower drainage level, in the bottom of the ditch.

In such a planted filter, the distribution of the filling materials and the arrangement of the effluent supply and discharge zones are different. For example, the filling materials situated at two of the opposite sides of the ditch have a larger granulometry. These are for example pebbles. The effluent supply is carried out directly in the ditch at one of these sides while the discharge is carried out at the opposite side.

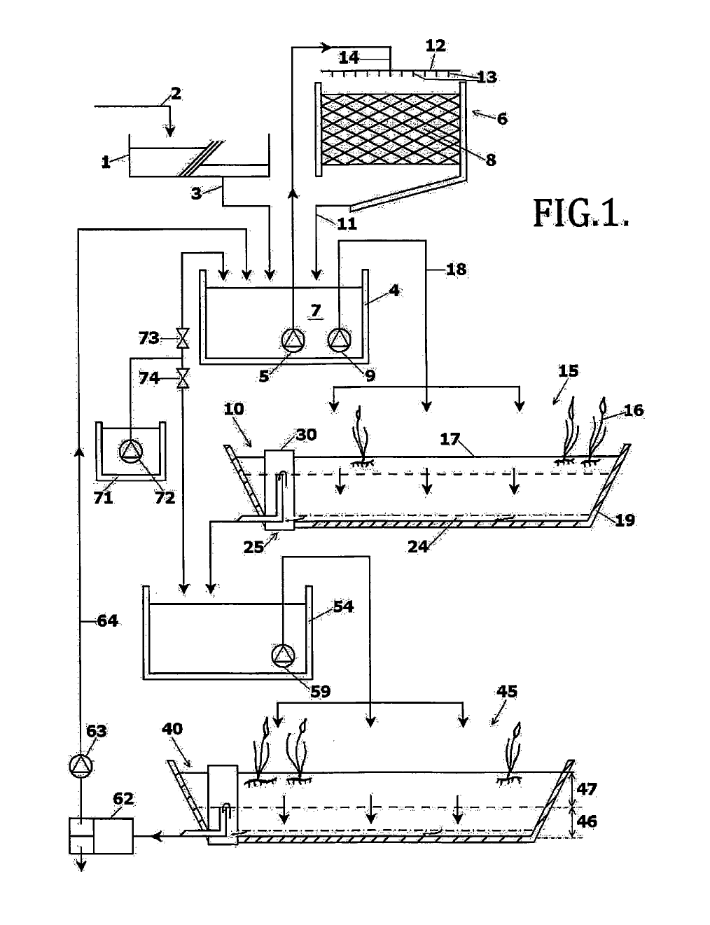

FIGS. 1, 2 and 3 show variants of an effluent treatment installation according to the invention. In these variants, a screening station 1 is first of all provided so as to prevent any risk of clogging and deposition of coarse waste towards the equipment situated downstream of the screening station. Advantageously, the screening station retains the elements with a mesh, or diameter, for example greater than 3 mm, contained in the untreated waste water effluent 2.

This may be an automatic screening sieve equipped for example with a filtration zone comprising a semi-cylindrical perforated metal sheet from which the waste is discharged by means of a webless screw. While the waste retained by the screening sieve is discharged upwards by means of the webless screw, the major part of the water restored by the effluent flows by gravity. The at least partially dried waste arrives in a compacting zone disposed at the end of the webless screw. The water restored during the compacting of the solid waste flows by gravity through openings provided in the compacting zone, for example through longitudinal slots.

The functioning of an automatic screening sieve, or any other screening device, passive or active, is well known to persons skilled in the art. Thus it is not necessary to provide any further details in this regard.

The water and effluent thus recovered are collected and brought, by means of a duct 3, to a first pumping station 4. The pumping station 4 comprises a first pump 5 for supplying a device 6 for the biological pretreatment of the effluent 7, by means for example of at least one bacterial bed 8.

In the following examples, an installation comprising the use of a bacterial bed for the biological pretreatment of effluent will be described. However, the invention may be implemented with other biological pretreatment devices, provided that these devices afford a treatment of 60% to 70% of the BOD₅, including not limitatively a lagoon (or lagooning) or a biological disc, etc.

In a first variant illustrated in FIG. 1, the pumping station 4 also comprises a second pump 9 for supplying a first nitrification-denitrification stage 10.

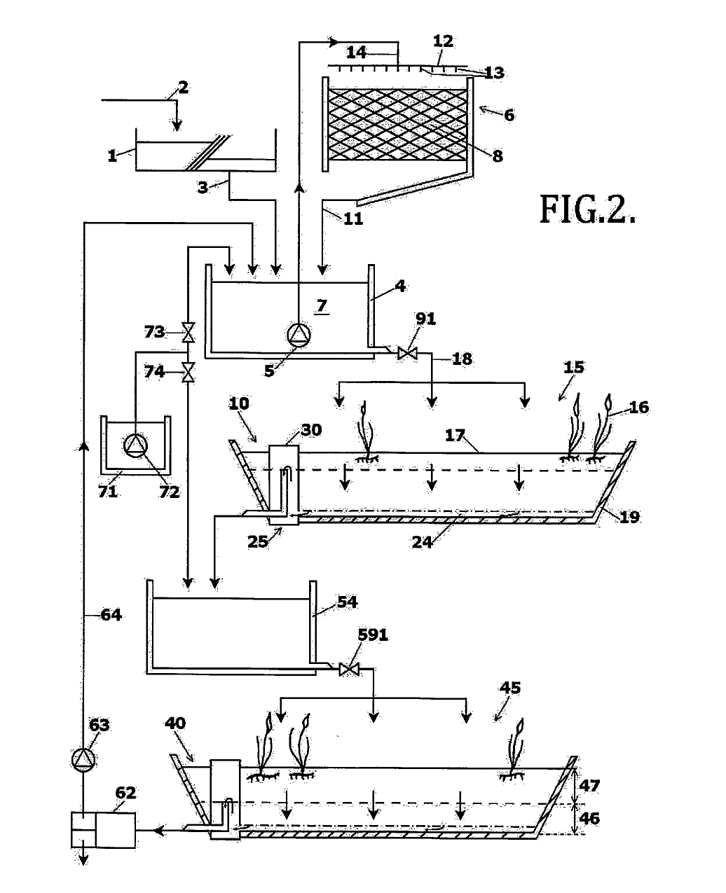

In another variant illustrated in FIG. 2, the pumping station 4 comprises a gravity feed by automatic valve 91 with water flush effect advantageously replacing the pump 9 for supplying the first nitrification-denitrification stage 10.

The bacterial bed 8 is an installation for fixed culture of the effluent 7 to be treated. The technique consists of trickling the effluent 7 to be treated over a solid support having a large developed surface. A culture of purifying microorganisms, the “biological film” or “biofilm”, develops on this solid support. The purifying microorganisms consume part of the carbonaceous pollution, in particular the highly soluble pollution. Thus the carbonaceous pollutions are fixed by means of the bacterial metabolism and development. When the thickness of the bacterial film becomes too great, it detaches from the support and is discharged by means of ducts 11. This is the pretreated effluent. The pretreated effluent thus formed is connected and conveyed to the pumping station 4.

The support material used in a bacterial bed 8 is generally an ordered lining, such as multichannel tubes or corrugated plates. They have a large developed surface because of the alveolar partitioning of the material. Such materials are for example described in the publications EP 1310299, EP 1142837 or U.S. Pat. No. 6,274,035.

The effluent 7 to be treated is sprayed at the top bacterial bed 8, by means of a spray arm 12 provided with a series of spray nozzles 13 (or sprinkler). For example, the spray arm is rotary, about a central supply barrel 14. This arrangement makes it possible to distribute the flow of effluent 7 to be treated over the top surface of the bacterial bed 8. Preferably, the distribution is carried out in the most even manner possible.

The microorganisms of the biofilm develop naturally, for example because of their presence in the effluent. The microorganisms may also be contributed by seeding, for example in order to promote the installation of a bacterial population.

Advantageously, the bacterial bed makes it possible on average to eliminate up to 70% of the BOD₅ of the effluent treated. On the other hand, it does not generally make it possible to eliminate the nitrogenous pollution.

The pumping station 4 therefore contains a mixture comprising effluent screened in the screening station 1, and pretreated effluent obtained at the discharge from the bacterial bed 8 of the biological pretreatment device 6. The pumping station 4 therefore represents also a tidal reservoir, the level of which can be controlled in particular according to the quantity of effluent to be treated coming from the screening station, and the treatment conditions at the nitrification-denitrification stage or stages.

The first nitrification-denitrification stage 10 comprises a filter 15 planted with vascular rhizome plants, for example reeds 16. The filter 15 planted with reeds is supplied at its top surface 17 with effluent 7 (which comprises effluent coming from the screening station 1 and pretreated effluent coming from the bacterial bed 8) by means of a feed pump 9, through pipes 18. A variant advantageously replaces the pump 9 with an automatic valve 91 with water flush effect for the gravity supply of the first stage 10 by means of the pipe 18 as illustrated in FIG. 2.

More precisely, the supply can be carried out for example by spraying or sprinkling of the top surface 17 of the filter 15 planted with vascular rhizome plants, or by flooding. The spraying or sprinkling is carried out by means of a spraying/sprinkling bar, fixed or movable, for example disposed above the surface 17 of the planted filter 15. The use of spray nozzles disposed at the top surface 17 of the filter can also be envisaged, but judged not to be very practical since the vegetative development of the plant would limit the efficacy thereof. Flooding is carried out by means of supply orifices disposed regularly, for example staggered, at the filter planted with reeds. A supply orifice is for example in the form of a vertical pipe that emerges above the top surface 17 of the filter 15 planted with reeds 16. To prevent gullying around the supply orifice, provision can be made for disposing gravel around the supply orifice.

The filter 15 planted with vascular rhizome plants, for example reeds 16, is produced by cut and fill. It comprises a ditch 19, the lateral walls 20 and bottom 21 of which are preferably produced from an impermeable material, in order to prevent contamination of the environment with effluent that is not yet purified or treated satisfactorily. It is in particular a geomembrane sandwiched in a protective geotextile.

The ditch 19 is filled from bottom to top with filling materials, the granulometry of which decreases from bottom to top. In the variant illustrated in FIG. 1, the planted filter 15 of the first nitrification-denitrification stage 10 is distinguished from the filter 45 of the following stage 40 by the granulometry of the various layers of filling materials. Other features make it possible to distinguish them. They will be dealt with in the remainder of the description.

In this case, the filter 15 planted with vascular rhizome plants comprises, from bottom to top, a draining layer 22 with a bottom consisting for example of pebbles, one or more intermediate layers of gravel and then one or more filtration layers 23 comprising gravel and sand. For example, the pebbles of the bottom draining layer 22 have a diameter of 20 to 60 mm, over a thickness of 10 cm, the intermediate layer of gravel has a thickness of 20 cm and contains gravel 10 to 20 mm in diameter. The filtering layers 23 contain first of all a thickness of 20 cm of gravel 4 to 10 mm in diameter and then, above, a 30 cm thick layer of gravel 2 to 5 mm in diameter, optionally mixed with sand.

The water percolates by gravity through the filtering layers 23, the intermediate layers and the draining layer 22. The percolated water is recovered at the bottom of the filter by a draining device comprising a series of drains 24 and which, preferably, converges to a discharge device 25 where the effluent that has flowed through the planted filter 15 collects.

The filter 15 planted with reeds comprises a flooded zone 26 and a non-flooded zone 27, the respective heights hD and hN of which are controlled by means of the device 25 discharging the percolated effluent 28.

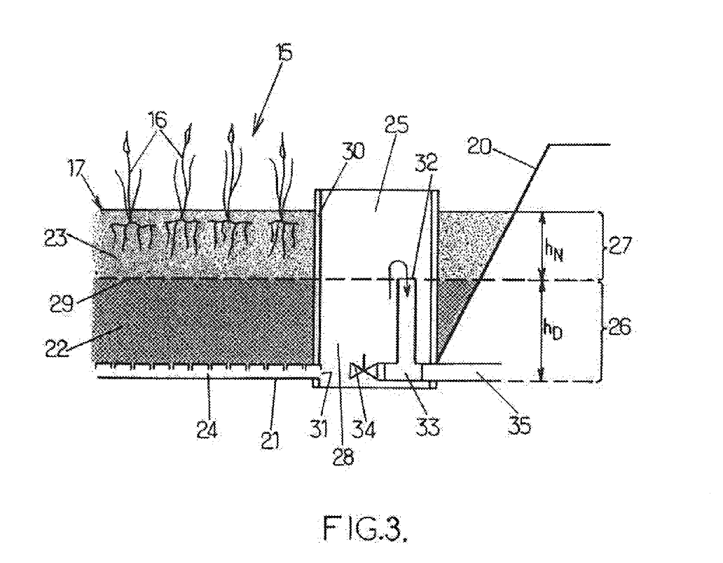

The device 25 discharging the percolated effluent 28 may be disposed outside the ditch 15, as illustrated in FIG. 1, or inside the ditch 15 as illustrated in FIG. 3. The discharge device 25 comprises a reservoir 30 provided with an orifice 31 supplying percolated effluent collected by the draining device. The percolated effluent 28 is discharged by a discharge orifice 32. The height of the discharge orifice 32 is intermediate between the bottom 21 of the filter 15 and the top surface 17. Thus the percolated effluent 28 accumulates in the reservoir 30 until the level 29 of effluent reaches the height of the discharge orifice 32, which enables it to be discharged. In this way, the flooded zone 26 forms in the bottom part of the filter 15 planted with reeds, while a non-flooded upper zone 27 is delimited. The level of water 29 in the planted filter 15 depends therefore on the height hD of the discharge orifice 32 of the discharge device 25.

According to a variant of the invention, the discharge orifice 32 corresponds to the top opening of a chimney 33. Advantageously, the height of the chimney 33 is adjustable. The chimney 33 communicates in its bottom part with a pipe 35 for overflow of the percolated effluent 28. In addition, it is possible to provide the bottom part of the chimney 33 with a drainage valve 34 to facilitate the drainage of the reservoir 30 and of the filter 15 planted with vascular rhizome plants.

According to another variant of the invention, not illustrated, the discharge orifice is in the form of a simple overflow provided in the wall of the reservoir 30, from which the percolated effluent 28 flows.

Vascular rhizome plants, for example reeds 16, are planted on the surface of the bed 15. Their vegetative development, in particular the root and rhizome development, promotes transfers of oxygen to the non-flooded upper zone 27, first by transfer from the leaf and stem system of the reeds, secondly because of the movement of the filling material caused by the root growth that represents preferential paths for the air through the filling material. The root development of the reeds also prevents encrusting of the surface 17 of the filter by the effluent brought from the pumping station.

Thus the non-flooded upper zone 27 is under aerobic conditions. It is favorable to the development of a nitrogen-fixing aerobic microbial flora, which uses the effluent brought on the surface 17 of the filter 15, as a source of carbon. Thus the degradation of the effluent on the surface by nitrogen-fixing bacteria facilitates a transfer of carbon to the flooded zone 26. This flooded zone is under anaerobic or preferably anoxic conditions. It thus allows the development of a denitrifying bacterial flora able to use the nitrites and nitrates produced by the nitrogen-fixing bacteria, as well as the related carbon sources, and to ensure the denitrification of the effluent.

Advantageously, the height hD of the flooded zone 26 is greater than the height hN of the non-flooded zone 27. In a particular variant of the invention, hD is 1.5 to 4 times greater than hN. In another variant, hD varies from 1.5 times to twice hN.

This arrangement of the planted filter prevents the carbonaceous supply of the denitrifying bacteria constituting a limiting factor for their metabolism, since the source of carbon comes from the non-flooded aerobic zone 27, regularly supplied with effluent. Furthermore, the contact time for the denitrifying bacteria with the effluent to be treated is increased by the immersion of the flooded zone 26.

The percolated effluent 28 is discharged for example to a second pumping station 54. The pumping station 54 comprises a pump 59 for supplying a second filter 45 planted with reeds. According to a variant of the invention illustrated in FIG. 2, the pump 59 is advantageously replaced by an automatic valve 591 with a water flush effect for the gravity supply of the second filter stage 45 planted with reeds.

The installation comprises a tank for storage of the coagulating agent 71 able to precipitate the phosphates in the effluent. Coagulating agents able to precipitate the phosphates in the effluent or purification sludge means any type of agent known for use thereof in physico-chemical dephosphatising. Such agents include in particular ammonium or iron salts, in particular alum, ferric chloride and ferrous sulfate. Other products such as ferrous chloride, sodium aluminate, prepolymerised aluminum chloride and prepolymerised alum have been the subject of tests (John Meunier Inc., 1996) and could also be used. In a preferred embodiment, the storage tank comprises ferric chloride salt.

The tank 71 comprises means for bringing the coagulating agents to the pumping station, for example a metering pump 72, which may be parameterized to adjust the period and flow rate of injection of the coagulating agents in the injection zone, for example a pumping station.

The metering pump 72 can inject the coagulating agents to the pumping station 4 or, as illustrated in FIG. 1, to the pumping station 54. This choice can be managed by virtue of two valves or two cocks 73 and 74, disposed downstream of the pump 72. The functioning of the pump 72 and the valves or cocks 73 and 74 can be controlled remotely and/or slaved or automated.

The metering pump may for example be controlled by means of a piezometric probe for detecting a low level of the effluent in the pumping station 4 or 54, constituting the threshold for starting the metering pump and a high level for stopping the metering pump.

At the discharge from the second nitrification-denitrification stage 40, the percolated effluent is discharged to the natural environment. According to a variant of the invention, part of the effluent at the discharge from the second stage is recirculated by means of a flow distributor 62 that returns the effluent to the pumping station 4 by means of a pump 63. According to a variant of the invention, not illustrated, the recirculation takes place by gravity by means of a pipe 64 without the pump 63. The other part is discharged to the natural environment. The recirculation level is adjustable from 0% to 200%.

Preferably, in the various variants of the invention, the functioning of the pumps 5, 9, 59, 63 or 72 is controlled remotely, slaved and/or automated.

The pumping station 4 or 54 may comprise a submersible agitator for agitating the coagulating agents in the pumping station 4 or 54.

Advantageously, the sludge containing the precipitates of phosphates and particulate phosphorus remain mainly on the surface of the planted filter 15 or 45. These are recovered when the filters are cleaned.

On average, the nitrification/denitrification treatment on the filter 15 planted with reeds eliminates up to 90% of the NTK nitrogen, at a minimum ambient temperature of approximately 12° C. In addition, approximately 95% of the BOD₅ is eliminated from the effluent discharged from the filter planted with reeds (global value, percolated effluent 28 with respect to the effluent to be treated issuing from the screening station).

As illustrated in FIG. 1, a second nitrification-denitrification stage 40, the functioning of which is in all respects comparable to that of the first nitrification-denitrification stage 10, may be provided in a variant of the invention.

As indicated above, the filters 15, 45 are distinguished in particular from each other by the granulometry of the filling materials used. They can also be distinguished by the height of the flooded zone, with respect to that of the non-flooded zone.

For example, the filter 45 of the second nitrification-denitrification stage comprises, from bottom to top, a draining layer with a bottom comprising pebbles (for example pebbles with a diameter of 20 to 60 mm, thickness 10 cm), then intermediate layers of gravel (for example gravel 10 to 20 mm in diameter, and above, 40 to 10 mm in diameter, each layer over a thickness of 10 mm), and top filtering layers (for example 20 cm of gravel 2 to 5 mm in diameter and above 30 cm of sand 0 to 4 mm in diameter).

Preferentially, the height hD2 of the flooded zone 46 of the second filter 45 is less than the height hN2 of the non-flooded zone 47 of the second filter 45. Advantageously, the hN2/hD2 ratios of the second filter 45 are reversed by comparison with the hN/hD ratios of the first filter 15.

Indeed, the percolated effluent 28 collected in the discharge device 25 of the first filter 15 contains much less carbonaceous material than the effluent and pretreated effluent 7 coming from the pumping station 4 and poured into the first nitrification-denitrification stage 10. In this variant, the percolated effluent 28 is poured into the second nitrification-denitrification stage 40.

The second nitrification-denitrification stage provides treatment of the residual nitrogenous pollution that remains in the effluent 28 coming from the second pumping station 54. Thus, at the discharge from the second filter 45, at a minimum ambient temperature of 12° C., the treatment of the effluent eliminates on average close to 99% of the BOD₅ and close to 96% of the NTK nitrogen (95% to 98% of the NTK nitrogen with respect to the effluent to be treated issuing from the screening station).

The functioning of the nitrification-denitrification stages will now be described in more detail. The nitrification-denitrification stages 10, 40 are preferably supplied by batches, that is to say a predetermined quantity of effluent is poured onto the filter planted with reeds, preferably after injection of coagulating agents in a suitable concentration for the precipitation of phosphates.

The triggering of a batch may depend for example on the level of effluent in the pumping stations 4 and 54. This makes it possible to best cover the surface of the planted filter with a film of effluent to be treated. The quality of the distribution of the effluent on the surface of the filter is very important since it determines the good aeration of the filter (in particular of the non-flooded zone) and the filtration of the effluent. It also enables the distribution of this sludge comprising the phosphatised precipitates on the surface of the planted filter.

Advantageously, each nitrification-denitrification stage is divided into a plurality of cells, preferably three cells, supplied with effluent by circular permutation. When one cell receives effluent, the others are not supplied. This functioning by alternation leaves sufficient time for the mineralization of the effluent and purification sludge in the non-supplied cells. A supply cycle may last for example for one week. This promotes a permanent functioning regime (transient functioning corresponding in particular to the filling of a cell).

The supply of the nitrification-denitrification stages and of the various cells may for example be semi-automatic or automatic, that is to say it requires or not occasional intervention from personnel in order to ensure the functioning of the installation. The permutation of one cell with another is generally automated, for example by the use of a device comprising a timer.

Furthermore, it is possible to provide level detectors, in particular at the pumping stations 4 and 54, in order to determine whether the reserve of effluent in the pumping station is sufficient to generate a batch for supplying the first nitrification-denitrification stage from the first pumping station 4, and to the second nitrification-denitrification stage 40 from the second pumping station 54. The same detectors may also control the metering pump for injecting coagulating agents into the pumping station 4 or 54 and controlling the agitator for mixing the coagulating agents with the effluent in the pumping station 4 or 54.

Making provision for controlling the discharge of the percolated effluent according to its quality, in particular according to its BOD₅ or its NTK nitrogen, can also be envisaged.

Among other advantages of the present invention, mention may be made of the fact that the development of the reeds at least partially masks the constructed part of the installation, which improves its integration in the landscape.

Tests carried out with an installation according to the invention comprising a device for metering ferric chloride salts for the chemical dephosphatisation showed that the phosphorus remains blocked on the surface of the filter, ensuring the level of reduction of the phosphorus at least 40%, this being able to be increased by simple increase of the dosing of salts injected into the pumping station.

The following table 1 presents the results of a measurement campaign carried out on effluent at the entry and discharge of the installation according to the present invention. In particular an efficiency of an 89% reduction for total phosphorus is obtained, much greater than 40%.

TABLE 1

| | CODb | BOD | MIS | NK | N—NH₄ | N—NO₂ | N—NO₃ | Ptotal | P—PO₄ |
|---|---|---|---|---|---|---|---|---|---|
| mg/l | | | | | | | | | |
| Entry | 2470 | 1018 | 1534 | 139 | 70.7 | 0.06 | 0.45 | 22.4 | 7.25 |
| Discharge | 34 | 6.7 | 8.7 | 2.6 | 1.15 | 0.04 | 14.8 | 2.4 | 2.35 |

Efficiency

| | | | | | | | | | |
|---|---|---|---|---|---|---|---|---|---|
| % | | | | | | | | | |
| E → S | 98.62 | 99.34 | 99.43 | 98.13 | 98.37 | 33.33 | — | 89.29 | 67.59 |

* CODb: COD over the raw sample

1. Effluent treatment method, comprising:
performing at least one biological nitrification-denitrification treatment of the effluent, by means of at least one filter planted with vascular rhizome plants, with vertical flow, the effluent constituting a source of carbon for the nitrification and for the denitrification, wherein, in permanent functioning regime, at least one nitrification-denitrification filter comprises a flooded lower zone and a non-flooded upper zone where respectively a biological nitrification treatment and a biological denitrification treatment take place, and
performing a physico-chemical dephosphatisation treatment of the effluent.

2. Method according to claim 1, characterized in that the physico-chemical dephosphatisation treatment consists of injecting coagulating agents which precipitate the phosphates in the effluent or purification sludge before the biological nitrification-denitrification treatment step.

3. Method according to claim 2, characterized in that the physico-chemical dephosphatisation treatment consists of injecting said coagulating agents in a concentration enabling the precipitation of the phosphates, and recovering the phosphatised precipitates or the particulate phosphorus trapped on the surface of the filter planted with vascular rhizome plants.

4. Method according to claim 1, characterized in that it also comprises a biological pretreatment of the effluent before the dephosphatisation step.

5. Method according to claim 4, characterized in that it also comprises the following steps:
a. the pretreated effluent from the biological pretreatment is recovered in a pumping station before the nitrification-denitrification step,
b. said coagulating agents are injected in the pumping station containing the effluent recovered at a.,
c. where applicable, the pretreated effluent is agitated in the pumping station after injection of the coagulating agents, so as to obtain a good dispersion of the coagulating agents in the pretreated effluent,
d. the pretreated effluent is discharged from the pumping station just after step b. and/or c., onto the filter planted with vascular rhizome plants,
e. the sludge containing the precipitates of phosphates and particulate phosphorus is recovered on the surface of the planted filter.

6. Effluent treatment method according to claim 1, wherein, in permanent functioning regime, the height of the flooded zone of at least one nitrification-denitrification filter is greater than or equal to the height of the non-flooded zone.

7. Effluent treatment installation for implementing the method according to claim 1, comprising:
at least one device for a biological pretreatment, said device being equipped with a supply of effluent to be treated and a discharge of the effluent obtained at the exit from said device,
at least one nitrification-denitrification stage comprising a filter planted with vascular rhizome plants, with vertical flow, the top surface of which is equipped with a supply of pretreated effluent coming at least partly from said biological pretreatment device and the bottom of which is equipped with a drainage device for collecting the effluent that have flowed through the planted filter,
a device for discharging the effluent collected from the drainage device comprising at least one discharge orifice disposed at a height lying between the bottom of the filter and the top surface of the filter, thus forming a flooded lower zone and a non-flooded upper zone in the planted filter,
means for injecting coagulating agents which precipitate the phosphates in the effluent or purification sludge.

8. The effluent treatment installation according to claim 7, characterized in that the means for injecting the coagulating agents which precipitate the phosphates in the effluent or purification sludge comprise:
a storage tank comprising the coagulating agents which precipitate the phosphates in the effluent or purification sludge,
a metering pump for injecting an appropriate concentration of salts into the pretreated effluent,
where applicable, means for the automatic control of the metering pump, for the controlled injection of an appropriate concentration of coagulating agents into the pretreated effluent,
where applicable, means for obtaining a good dispersion of the coagulating agents in the pretreated effluent in the injection zone.

9. The effluent treatment installation according to claim 5, wherein the effluent discharge device comprises a reservoir provided with at least one orifice for supplying effluent collected by the drainage device and provided with at least one effluent discharge orifice, said discharge orifice being in the form of an overflow.

10. The effluent treatment installation according to claim 5, wherein the height of at least one discharge orifice is controlled.

11. The effluent treatment installation according to claim 5, comprising at least two successive nitrification-denitrification stages, the height of the flooded zone of the first stage being different from the height of the flooded zone of at least one following stage.

12. The effluent treatment installation according to claim 11, characterized in that it comprises
a. a first pumping station recovering at least the pretreated effluent,
b. at least one second pumping station recovering the effluent from a preceding stage and means for bringing the effluent to the following nitrification-denitrification stage, and
c. a device for injecting coagulating agents for the dephosphatisation of the effluent in at least one of the pumping stations.

13. The effluent treatment installation according to claim 12, characterized in that the device for injecting the coagulating agents for the dephosphatisation comprises
a tank for storing the coagulating agents, and
means for bringing the coagulating agents into at least the first and/or second pumping station.

14. The effluent treatment installation according to claim 5, wherein the planted filter of each nitrification-denitrification stage is divided into a plurality of cells, each cell being supplied with effluent by circular permutation.

15. The effluent treatment installation according to claim 5, also comprising a device for recirculating the effluent collected by a drainage device to at least one preceding nitrification-denitrification stage and/or to the bacterial bed.

16. The effluent treatment installation according to claim 15, wherein the effluent recirculation device is slaved at least to a detector for the volume of effluent to be treated.

17. The method of claim 1, wherein said filter planted with vascular rhizome plants is a filter planted with reeds.

18. The method of claim 2, wherein said coagulating agents are ferric chloride salts.

19. The method of claim 4, wherein said biological treatment is by means selected from the group consisting of a biological disc, a lagoon, a lagooning and a bacterial bed.

20. The effluent treatment installation of claim 7, wherein said filter planted with vascular rhizome plants is a filter planted with reeds.

21. The effluent treatment installation of claim 7, wherein said device for biological pretreatment is selected from the group consisting of a biological disc, a lagoon, a lagooning and a bacterial bed.

22. The effluent treatment installation of claim 7, wherein means for injecting coagulating agents are situated downstream from the biological pretreatment device.
